(19) United States
(12) Patent Application Publication
(10) Pub. No.: US 2013/0078046 A1
(43) Pub. Date: Mar. 28, 2013

(54) PROTECTING COVER FOR AN X-AXIAL SCREW OF A CARVING MACHINE

(71) Applicant: Bor-Yann CHUANG, Taichung (TW)

(72) Inventor: Bor-Yann CHUANG, Taichung (TW)

(21) Appl. No.: 13/241,125

(22) Filed: Sep. 22, 2011

(51) Int. Cl. B23Q 11/08

(52) U.S. Cl. 409/134

(57) ABSTRACT

A protecting cover for an X-axial screw of a carving machine includes a driven base positioned between an X-axial sliding base and an X-axial screw, and a hood. A through groove is bored in the driven base for the hood to pass through to surround the X-axial screw, enabling the driven base to move freely along the hood to effectively protect the X-axial screw. And as the hood doesn't have to be extended or compressed while the X-axial sliding base is moving, it can avoid the disadvantage of being easily broken that would happen to a conventional one owing to constant extending and compressing. So the protecting cover of the invention is pretty reliable.

### BACKGROUND OF THE INVENTION

1. Field of the Invention

This invention relates to a protecting cover for an X-axial screw of a carving machine.

2. Description of the Prior Art

Commonly, a carving machine is used to create characters, pictures, etc. on a workpiece. As shown in FIG. 1, a conventional carving machine 200 is mainly composed of a worktable 201 movable along a Y axis, a rectangular column 202 installed above the worktable 201, an X-axial sliding base 203 set at one side of the rectangular column 202 to move along X axis, a Z-axial sliding base 204 set on the X-axial sliding base 203 to move along Z axis, and a knife 300 combined with the Z-axial sliding base 204. With the knife 300 moved precisely to locations expected, the carving machine 200 can do a carving according to what is required.

Usually, the worktable 201, the X-axial sliding base 203 and the Z-axial sliding base 204 are driven by screws to carry out sliding. In order to prevent the X-axial sliding base 203 from being interfered to slide, two sides of the rectangular column 202 are respectively positioned with a fixing base 205, with an X-axial screw 206 pivotally installed between the fixing bases 205. A motor 207 is connected with one side of the X-axial screw 206. The X-axial sliding base 203 is bored with a threaded hole 208 to threadably engage with the X-axial screw 206, so that the motor 207 can drive the X-axial screw 206 to enable the X-axial sliding base 203 to slide along X axis.

As the X-axial screw 206 is exposed at the outside of the rectangular column 202, it is apt to be contaminated with wastes cut off the workpiece, possible to stick the X-axial screw 206 and the X-axial sliding base 203, which may be deadlocked or damaged for the worse. To improve the disadvantage mentioned above, two sides of the X-axial sliding base 203 have been respectively installed with an extendable protecting cover 209 having one end fixed with the corresponding fixing base 205, as shown in FIG. 2. So the X-axial screw 206 can be protected, and the X-axial sliding base 203 can slide freely as the protecting cover 209 can be extended freely.

However, as the protecting covers 209 have to be alternately extended and compressed constantly, they can easily get fatigued and broken at the bending portions. Therefore, the protecting cover 209 has to be replaced with a new one constantly. And wastes can possibly enter the protecting cover 209 if damage is not found immediately.

### SUMMARY OF THE INVENTION

The object of this invention is to offer a protecting cover that can effectively protect an X-axial screw of a carving machine for quite a long time without being replaced with a new one.

The protecting cover of the invention can be installed in a carving machine, which includes a worktable, a rectangular column installed above the worktable, an X-axial screw pivotally installed on the rectangular column, and an X-axial sliding base set at one side of the rectangular column to move axially along the X-axial screw. The protecting cover is provided with a driven base positioned on the X-axial sliding base, and a hood. The driven base is provided with a threaded hole to threadably engage with the X-axial screw, and a U-shaped through groove bored along an axis of the X-axial screw to surround nearly half the threaded hole. The hood is shaped as a lengthy plate with a cross-section corresponding to that of the through groove, penetrating through the through groove to surround nearly half the X-axial screw.

As the hood penetrates through the through groove of the driven base to surround nearly half the screw, the driven base can freely move along the hood without interfering with each other while the X-axial sliding base is moving. Thus the screw is completely covered and effectively protected by the hood. And because the hood doesn't have to be extended or compressed while the X-axial sliding base is moving, it can be made of rigid materials, such as metals, with an excellent reliability to serve for quite a long time without being replaced with a new one. Therefore the protecting shelter of the invention can effectively overcome the disadvantage of the conventional one needing to replace a new one frequently.

### BRIEF DESCRIPTION OF DRAWINGS

This invention is better understood by referring to the accompanying drawings, wherein:

FIG. 1 is a perspective view of a conventional carving machine;

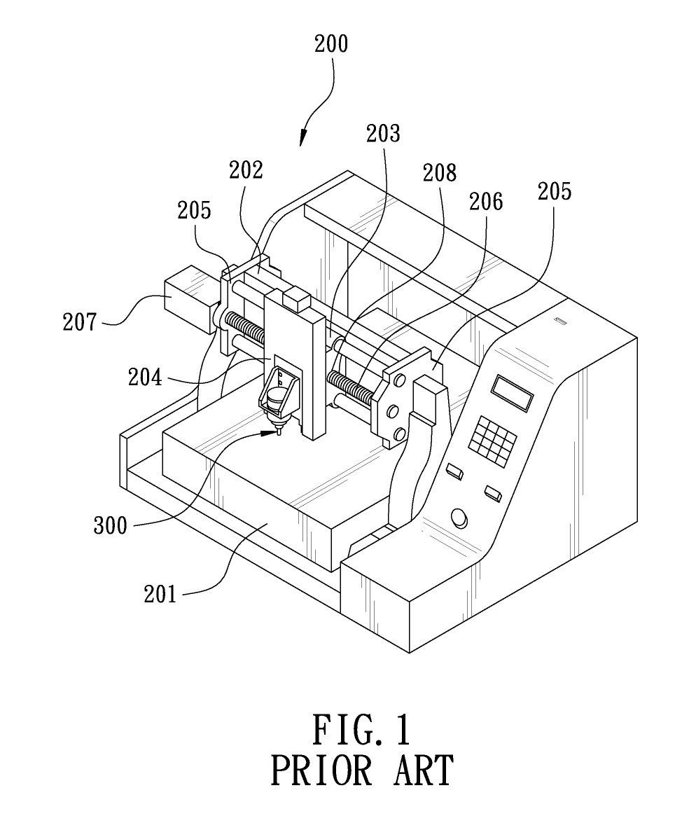

FIG. 2 is a perspective view of another conventional carving machine;

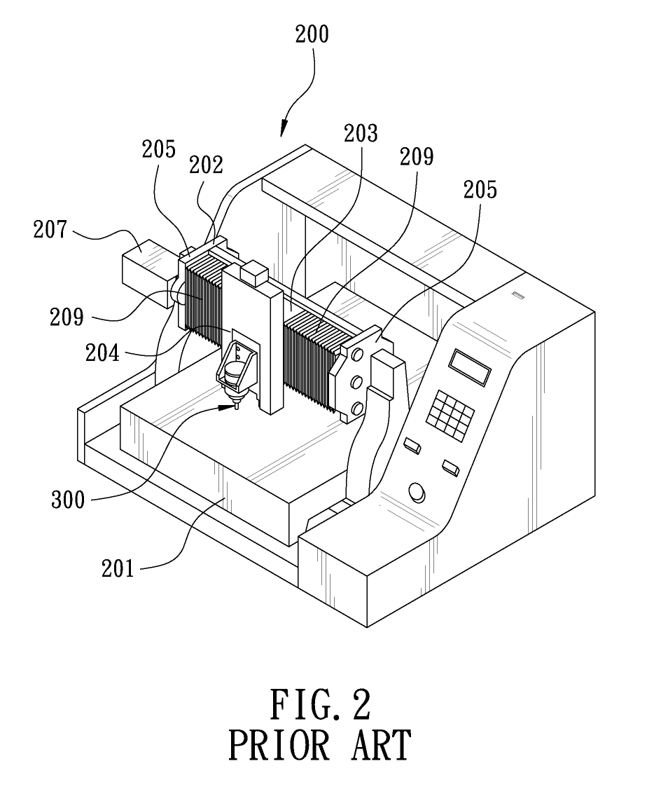

FIG. 3 is a perspective view of a preferred embodiment of a protecting cover for an X-axial screw of a carving machine in the present invention;

FIG. 4 is a partial exploded perspective view of the preferred embodiment of a protecting cover for an X-axial screw of a carving machine in the present invention;

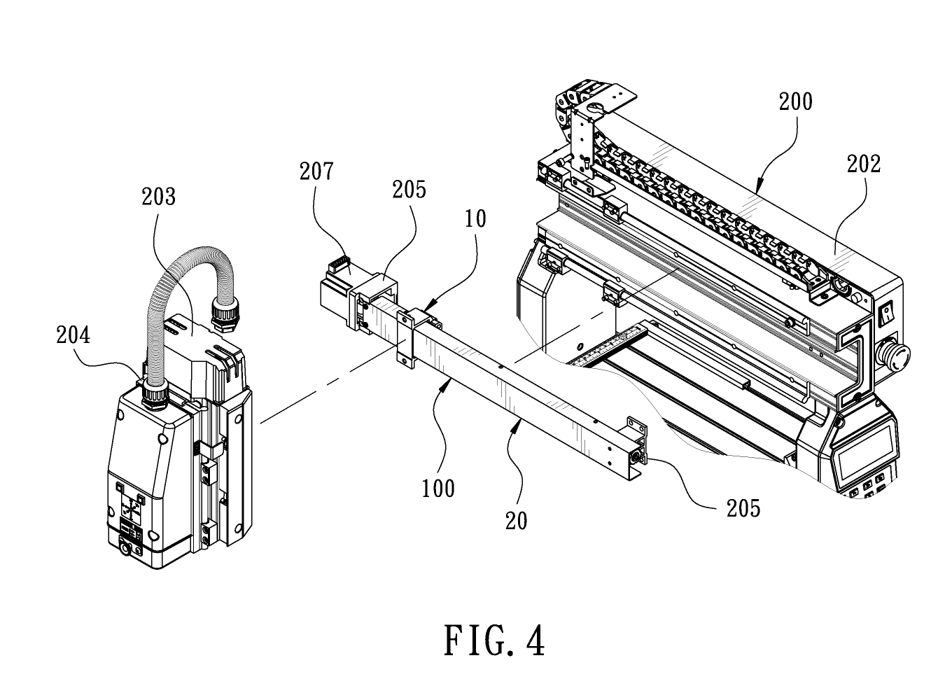

FIG. 5 is an exploded perspective view of the preferred embodiment of a protecting cover for an X-axial screw of a carving machine in the present invention;

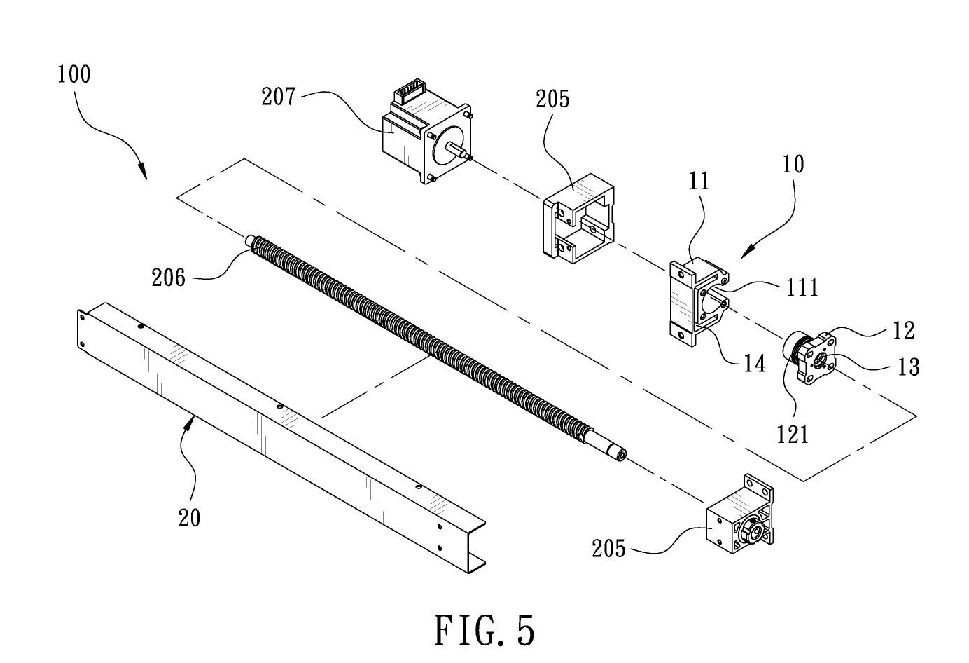

FIG. 6 is a partial magnified side cross-sectional view of the preferred embodiment of a protecting cover for an X-axial screw of a carving machine in the present invention; and

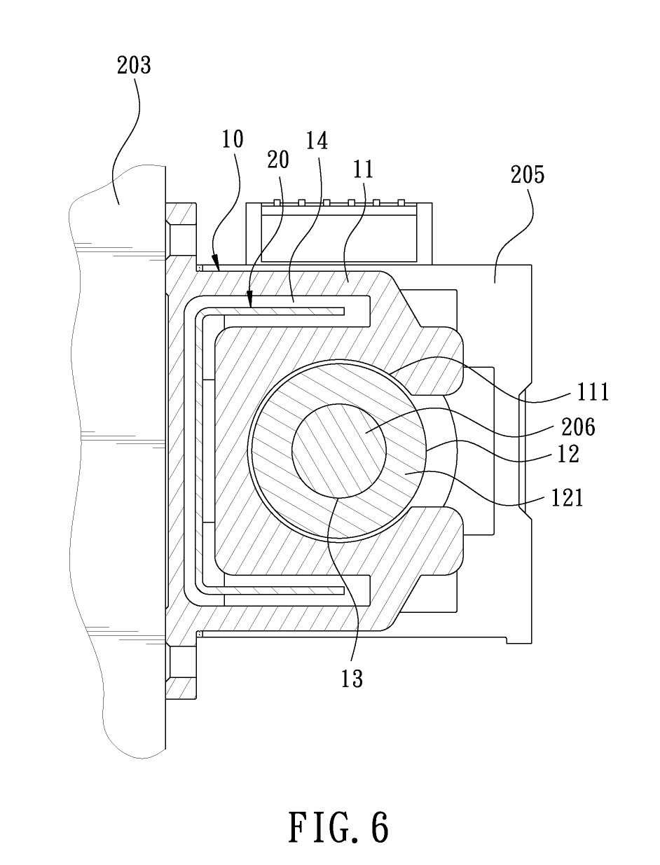

FIG. 7 is a partial magnified top cross-sectional view of the preferred embodiment of a protecting cover for an X-axial screw of a carving machine in the present invention.

### DETAILED DESCRIPTION OF THE PREFERRED EMBODIMENT

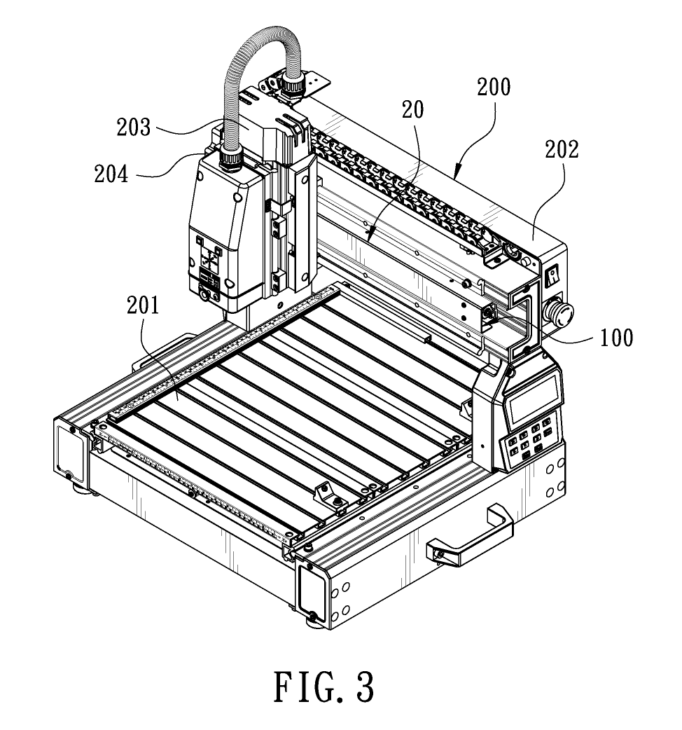

FIGS. 3˜6 show a preferred embodiment of a protecting cover 100 for an X-axial screw of a carving machine in the present invention. The protecting cover 100 is installed in a carving machine 200, which, for convenient description, is the same as the one described in the prior art. Briefly, the carving machine 200 is composed of a worktable 201, a rectangular column 202 installed above the worktable 201, a pair of fixing bases 205 pivotally positioned on the rectangular column 202, an X-axial screw 206 pivotally installed between the fixing bases 205, a motor 207 connected with one end of the X-axial screw 206, and an X-axial sliding base 203 set at one side of the rectangular column 202 to move axially along the X-axial screw 206. The protecting cover 209 includes a driven base 10 and a hood 20.

The driven base 10 is positioned on the X-axial sliding base 203, provided with a fixing portion 11 to position on the X-axial sliding base 203, and a threaded portion 12 engaged in one side of the fixing portion 11. In addition, a threaded hole 13 is correspondingly bored in the threaded portion 12 to threadably engage with the X-axial screw 206. The fixing portion 11 has a through hole 111 to let the X-axial screw 206 pass through. The threaded portion 12 is provided with a projection 121 to correspondingly engage with the through hole 111 of the fixing portion and bored through with the threaded hole 13. Moreover, a through groove 14 shaped as a long plate in its cross-section is bored along the axis of the X-axial screw 206 in the fixing portion 11, surrounding nearly half the threaded hole 13.

The hood 20 is formed as a lengthy plate, with a cross-sectional shape corresponding to that of the through groove 14. So can the hood 20 penetrate through the through groove 14 to surround nearly half the X-axial screw 206. The hood 20 has two ends respectively connected with the fixing bases 205.

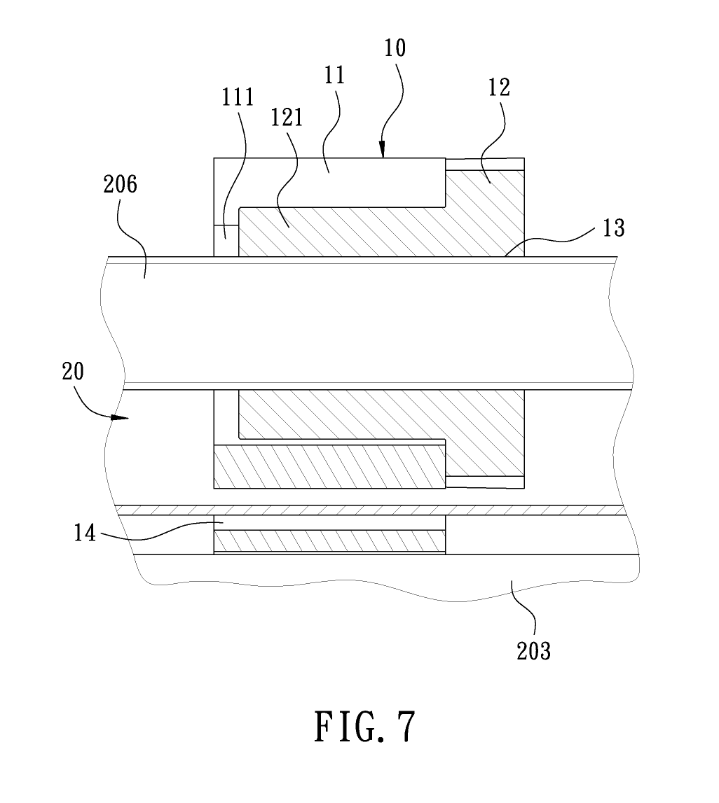

In using, as shown in FIG. 7, when a workpiece (not shown) is to be carved by the carving machine 200, it is first positioned on the worktable 201. Next, the carving machine 200 is started to work in accordance to a user's setting, enabling the worktable 201, the X-axial sliding base 203 and the Z-axial sliding base 204 to move so as to precisely position the knife 300 (not shown) to work successively. It has to be noticed that as the hood 20 penetrates through the through groove 14 of the driven base 10 to surround the X-axial screw 206, the driven base 10 can freely move along the hood 20 without interfering with each other while the X-axial sliding base 203 is moving. Thus the X-axial screw 206 is completely covered by the hood 20, protected from being damaged by wastes. Moreover, as the hood 20 doesn't have to be extended or compressed while the X-axial sliding base 203 is moving, it can be made of rigid materials, such as metals, with an excellent reliability to serve for quite a long time. Therefore the protecting cover 100 of the invention can effectively overcome the disadvantage of the conventional one needing to replace a new one frequently.

While the preferred embodiment of the invention has been described above, it will be recognized and understood that various modifications may be made therein and the appended claims are intended to cover all such modifications that may fall within the spirit and scope of the invention.

What is claimed is:

1. A protecting cover for an X-axial screw of a carving machine;
said protecting cover installed in a carving machine, said carving machine composed of a worktable, a rectangular column installed above said worktable, an X-axial screw pivotally installed at one side of said rectangular column, an X-axial sliding base set at one side of said rectangular column to move axially along said X-axial screw, said protecting cover comprising:
a driven base positioned on said X-axial sliding base and provided with a threaded hole to threadably engage with said X-axial screw, a plate-shaped through groove bored along an axis of said X-axial screw to surround nearly half said threaded hole; and
a hood shaped as a lengthy plate having a cross-sectional form corresponding to that of said through groove, said hood penetrating through said through groove to surround nearly half said X-axial screw.

2. The protecting cover for an X-axial screw of a carving machine as claimed in claim 1, wherein said driven base is provided with a fixing portion positioned on said X-axial sliding base, a through hole bored in said driven base to let said X-axial screw pass through, a threaded portion installed at one side of said fixing portion and having a projection corresponding to said through hole with said threaded hole penetrating it.

3. The protecting cover for an X-axial screw of a carving machine as claimed in claim 1, wherein said through groove of said driven base and said hood have a same U-shaped cross-section.
